(19) United States
(12) Patent Application Publication
(10) Pub. No.: US 2016/0259578 A1
(43) Pub. Date: Sep. 8, 2016

(54) APPARATUS AND METHOD FOR DETECTING PERFORMANCE DETERIORATION IN A VIRTUALIZATION SYSTEM

(71) Applicant: FUJITSU LIMITED, Kawasaki-shi (JP)

(72) Inventor: Akira Hirai, Kawasaki (JP)

(73) Assignee: FUJITSU LIMITED, Kawasaki-shi (JP)

(21) Appl. No.: 15/006,593

(22) Filed: Jan. 26, 2016

(30) Foreign Application Priority Data
Mar. 5, 2015 (JP) 2015-043959

(51) Int. Cl. G06F 3/06; G06F 9/455

(52) U.S. Cl. CPC G06F 3/0619; G06F 3/065; G06F 3/067; G06F 3/0665; G06F 9/45558; G06F 2009/45562

(57) ABSTRACT

A management device is configured to manage first and second information processing devices. The management device performs movement control to move an operating virtual machine set on the first information processing device to the second information processing device, and conducts performance measurement of the first information processing device in a state where the operating virtual machine set on the first information processing device is moved from the first information processing device to the second information processing device.

### CROSS-REFERENCE TO RELATED APPLICATION

This application is based upon and claims the benefit of priority of the prior Japanese Patent Application No. 2015-043959, filed on Mar. 5, 2015, the entire contents of which are incorporated herein by reference.

### FIELD

The embodiments discussed herein are related to apparatus and method for detecting performance deterioration in a virtualization system.

### BACKGROUND

In recent years, an information technology (IT) system on which a server is centered as an information processing device has widely used a virtualization system in order to increase efficiency or cut down maintenance and management costs. In a host server of the virtualization system, a guest virtual machine (VM) is set up in response to a user's request.

In an operation of such a virtualization system, the system performance including the application performance on a guest virtual machine (VM) may deteriorate during a long operation time.

For example, in a case where multiple users operate virtual desktop services on a host server of a virtualization system, application processing times on the virtual desktops may become long or the virtual desktops may respond to input/output with delay.

Thus, desired is operation management that maintains the system performance by detecting/analyzing occurrence of performance deterioration in the virtualization system and solving the deterioration of system performance as described above.

To this end, as illustrated in FIG. 21, for example, a virtualization system is provided with an operation management server, and the operation management server manages operation of a host server in the virtualization system. On hardware of the host server of the virtualization system, a management operating system (OS) is started and a hypervisor is also started on the management OS. Then, on the hypervisor, guest VMs are built and set in response to users' requests. Note that the host server includes a management OS application. In addition, each guest VM includes a guest OS and a guest application. An application may be hereinafter referred to as app. In addition, a host server of a virtualization system may also be referred to as a virtualization system host.

The operation management server first collects the following information (a1) and (a2) by executing operation management software:

(a1) An operating status, the number of input/output (I/O) processes, or an I/O performance value (hereinafter referred to as the I/O performance number/performance) of a central processing unit (CPU) that functions as a management OS or a hypervisor on a host server of a virtualization system; and

(a2) CPU allocation or the number of I/O processes/performance of a guest VM.

Then, the operation management server analyzes a change or variation in load status among multiple guest VMs (CPU load or I/O load for every guest VM) on a same host server, based on the collected information (a1) and (a2), by executing the operation management software. In addition, based on a result of the analysis, the operation management server implements performance maintenance and management of the virtualization system.

Related arts are disclosed, for example, in Japanese Laid-open Patent Publication Nos. 2010-237793 and 2010-134557.

### SUMMARY

According to an aspect of the invention, a system includes first and second information processing devices and a management device managing the first and second information processing devices. The management device performs movement control to move an operating virtual machine set on the first information processing device to the second information processing device, and conducts performance measurement of the first information processing device in a state where the operating virtual machine set on the first information processing device is moved from the first information processing device to the second information processing device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an overview (performance measurement) of a method of managing a virtualization system, according to an embodiment;

FIGS. 2A to 2D are diagrams illustrating an example of an overview (a VM rotation procedure and a measurement procedure of an in-operation performance value) of a method of managing a virtualization system, according to an embodiment;

FIG. 3 is a diagram illustrating an example of an overview (a rebuilding procedure of host servers) of a method of managing a virtualization system, according to an embodiment;

FIG. 4 is a diagram illustrating an example of a functional configuration of a virtualization system including an operation management server, according to an embodiment;

FIG. 5 is a diagram illustrating an example of a hardware configuration of a computer as an operation management server, according to an embodiment;

FIG. 6 is a diagram illustrating an example of an operational flowchart for action (initial building process of a virtualization system host server) of an operation management server, according to an embodiment;

FIG. 7 is a diagram illustrating an example of an operational flowchart for action (performance measurement, threshold judgment, and rebuilding process during operation) of an operation management server, according to an embodiment;

FIG. 8 is a diagram illustrating an in-operation configuration of a first example of a virtualization system, according to an embodiment;

FIG. 9 is a diagram illustrating an example of a building procedure script of a virtualization system host server, according to an embodiment;

FIG. 10 is a diagram illustrating an example of a virtualization system host information table corresponding to a virtualization system of the first example illustrated in FIG. 8, according to an embodiment;

FIG. 11 is a diagram illustrating an example of a threshold table set for a virtualization system of the first example illustrated in FIG. 8, according to an embodiment;

FIG. 12 is a diagram illustrating an example of a rotation table set for a virtualization system of the first example illustrated in FIG. 8, according to an embodiment;

FIG. 13 is a diagram illustrating an example of a benchmark performance value table in which an initial performance value measured for a virtualization system of the first example illustrated in FIG. 8 is recorded, according to an embodiment;

FIG. 14 is a diagram illustrating an example of a benchmark performance value table in which an in-operation performance value measured for a virtualization system of the first example illustrated in FIG. 8 is recorded, according to an embodiment;

FIG. 15 is a diagram illustrating an example of an in-operation configuration of a second example of a virtualization system, according to an embodiment;

FIG. 16 is a diagram illustrating an example of a virtualization system host information table corresponding to a virtualization system of the second example illustrated in FIG. 15, according to an embodiment;

FIG. 17 is a diagram illustrating an example of a threshold table set for a virtualization system of the second example illustrated in FIG. 15, according to an embodiment;

FIG. 18 is a diagram illustrating an example of a rotation table set for a virtualization system of the second example illustrated in FIG. 15, according to an embodiment;

FIG. 19 is a diagram illustrating an example of a benchmark performance value table in which an initial performance value measured for a virtualization system of the second example illustrated in FIG. 15 is recorded, according to an embodiment;

FIG. 20 is a diagram illustrating an example of a benchmark performance value table in which an in-operation performance value measured for a virtualization system of the second example illustrated in FIG. 15 is recorded, according to an embodiment; and

FIG. 21 is a diagram illustrating an example of a virtualization system including an operation management server that performs management by means of existing operation management software, and a management procedure by means of the existing operation management software.

### DESCRIPTION OF EMBODIMENTS

When the application performance on guest VMs deteriorates and load status of a certain guest VM increases, it is possible to determine that the certain guest VM has a deterioration factor and to take action such as moving the certain guest VM to another host server. If there is no change in the load status of any guest VM, however, it may be difficult to examine the deterioration factor.

When the performance of a guest VM deteriorates although there is no change in the load status of any guest VM, the host system may have a deterioration factor (performance problem or performance deterioration) such as items (b1) to (b4) listed below (management OS, a hypervisor, and management OS app in a host server):

(b1) Disk cluttered due to accumulation of unwanted log files and the like, or cumulative updates of an OS, a driver, an app, and the like;

(b2) Fragmentation of a file system;

(b3) Enlargement and fragmentation of a registry; and

(b4) Inadvertent change in the environment.

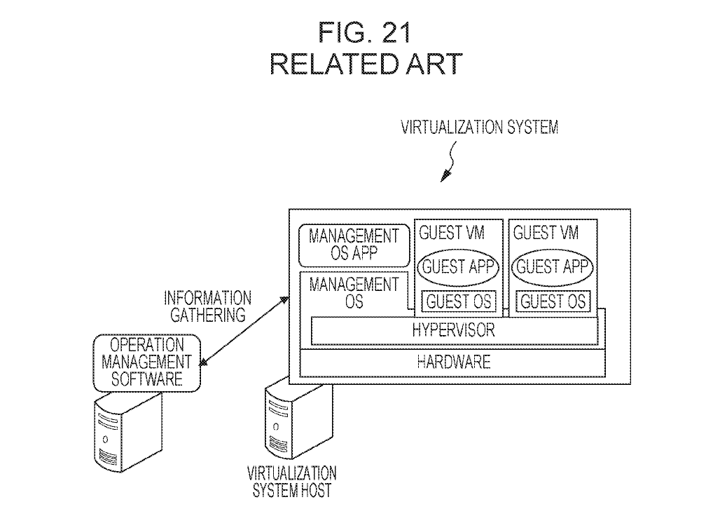

However, as described above with reference to FIG. 21, the existing operation management software is capable of analyzing the load statuses of multiple guest VMs on the host server, but is incapable of knowing the status of the host system on which the guest VMs are set. Therefore, in order to detect any performance deterioration such as the items (b1) to (b4) listed above on the host system, and to cope with the performance deterioration, a manager manually collects and analyzes information of an individual item, and takes action against the detected factor. Thus, a significant time (a few days or more) or effort is consumed to detect or cope with performance deterioration.

With reference to the drawings, an information processing system, a management device, and an information processing system management method, which are disclosed in this application, are hereinafter described in detail. Note, however, that the embodiments described below are merely illustrative, and are not intended to exclude application of various modifications or technologies which are not clearly indicated in the embodiments. More specifically, this embodiment may be modified and implemented in various manners without departing from the intent of the embodiment. In addition, each figure is not intended to include only components illustrated in the figure and may include any other function. Then, each embodiment may be combined as appropriate in a range that does not contradict processing content.

### [1] Overview of a Method of Managing a Virtualization System

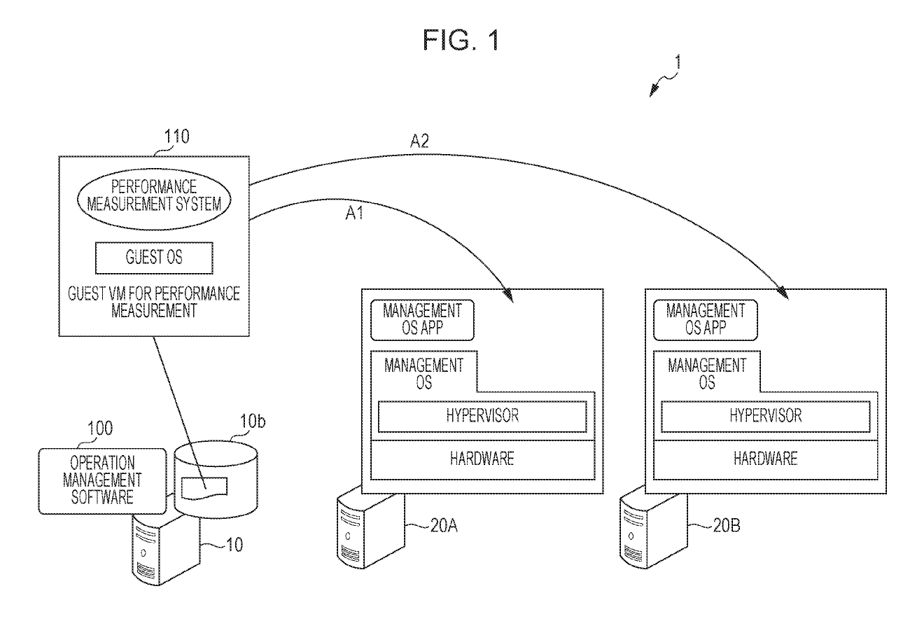

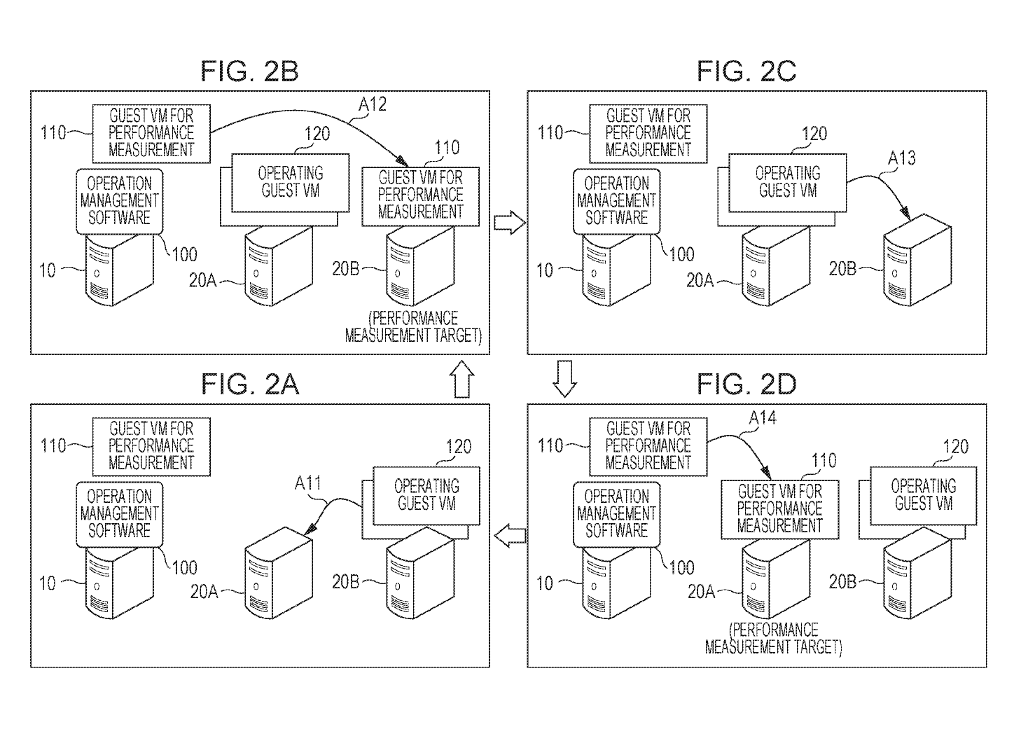

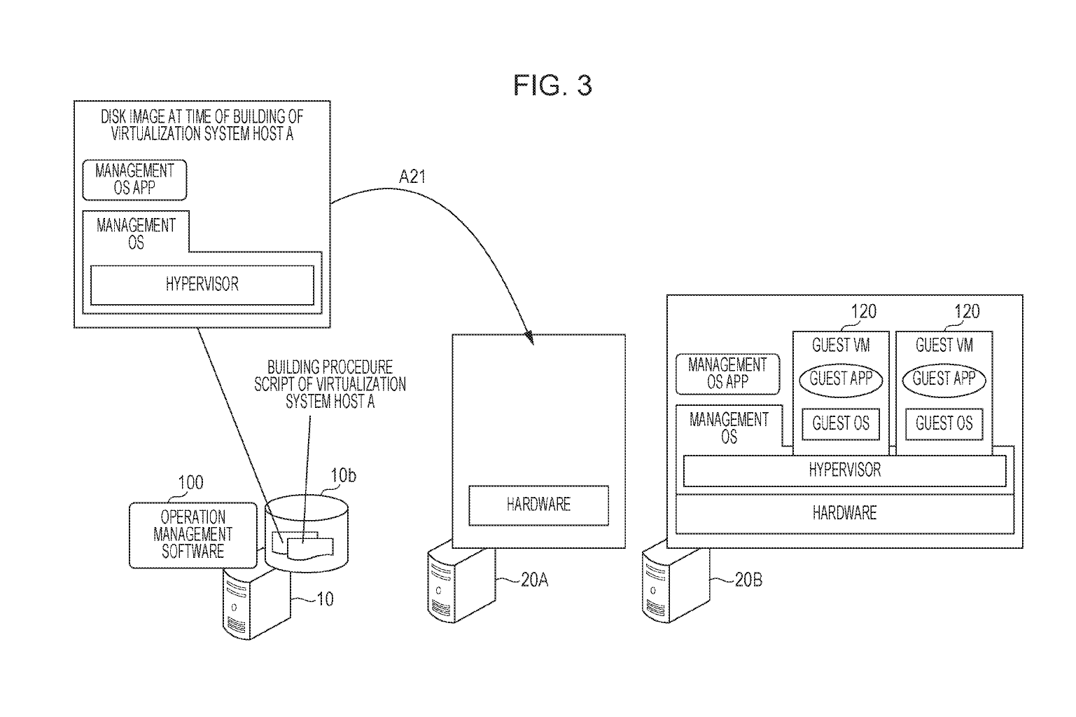

First, an overview of a method of managing a virtualization system (information processing system) 1 of this embodiment is described with reference to FIGS. 1 to 3. Note that FIGS. 1 to 3 are views illustrating the overview of the method of managing the virtualization system 1 of this embodiment. In particular, FIG. 1 is a view illustrating performance measurement of this embodiment, FIGS. 2A to 2D are views illustrating a VM rotation procedure and a measurement procedure of an in-operation performance value of this embodiment, and FIG. 3 is a view illustrating a rebuilding procedure of host servers 20A, 20B.

[1-1] Performance Measurement

As illustrated in FIG. 1, the virtualization system 1 of this embodiment includes virtualization system host servers (information processing devices) 20A, 20B, and an operation management server (management device) 10 that manages these virtualization system host servers 20A, 20B. FIG. 1 illustrates the virtualization system 1 including servers 20A, 20B. Note that the virtualization system host servers 20A, 20B may be respectively described as virtualization system hosts A, B or simply hosts A, B hereinafter.

In addition, as illustrated in FIG. 1, an image of a guest VM for performance measurement 110, which is a guest VM dedicated to conduct performance measurement of the host servers 20A, 20B, is created and stored in advance, in the operation management server 10 (storage unit 10b) in the virtualization system 1 of this embodiment. The guest VM for performance measurement 110 includes a guest OS, and a performance measurement program running on the guest OS to implement a performance measurement function of the host servers 20A, 20B.

In this embodiment, the guest VM for performance measurement 110 as described above is activated on the host servers 20A, 20B at a timing of building of the virtualization system 1 (when operation starts), at any timing such as a timing upon elapse of a predetermined period of time, or at a timing of performance measurement, such as a timing of rebuilding of the host server 20A, 20B. Any timing is set in advance by a manager or the like in the storage unit 10b (rotation table T3 to be described below), and may be only once after the predetermined period of time elapses, a certain cycle (every certain period of time), or a random cycle, or the like.

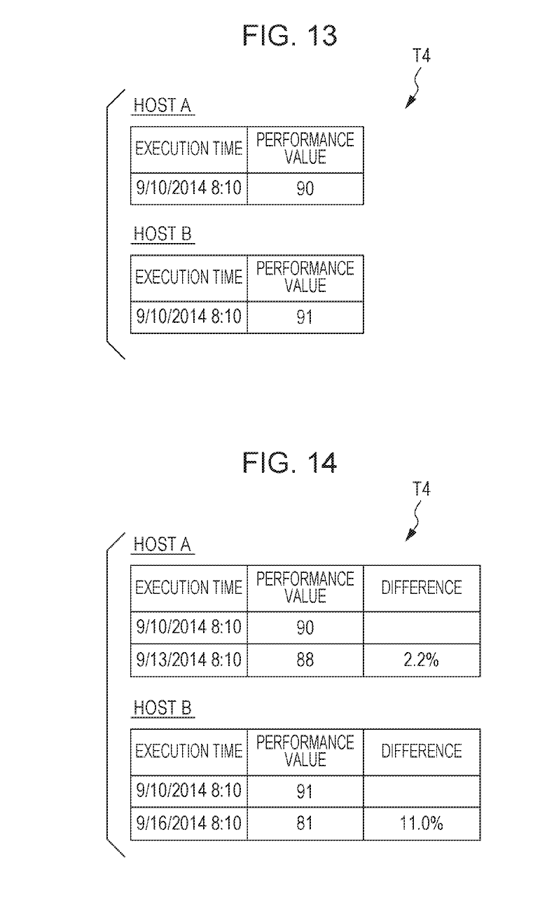

The guest VM for performance measurement 110 being activated on the host servers 20A, 20B, a performance measurement program is run, and a micro-benchmark test or an application benchmark test is performed. A micro-benchmark test measures CPU performance, I/O performance, system call performance, process switching performance, or the like. In addition, an application benchmark test measures performance of composite processing, such as table calculation or database access. A performance value of each of the measured host servers 20A, 20B is transmitted from respective host servers 20A, 20B to the operation management server 10 by way of a management network 18a, and saved in the storage unit 10b (benchmark performance value table T4 to be described below). In addition, in this embodiment, in the operation management server 10, one performance value is calculated/acquired as a performance measurement result, based on various performance measured by the micro-benchmark test or application benchmark test (see FIGS. 13, 14, 19, and 20).

However, in order to measure a performance value on each of the host servers 20A, 20B that do not have an operating guest VM 120 (see FIGS. 2A to 2D, or the like), the operating guest VM 120 (see FIGS. 2A to 2D, or the like) set on a host server (first information processing device) targeted for performance measurement is moved to another host server (second information processing device) at every timing of performance measurement mentioned above.

Then, to make conditions of performance measurement identical at any timing of performance measurement timing of various types as described above, an image of the guest VM for performance measurement 110 is copied (cloning) to the host server targeted for performance measurement, and performance measurement of the host server targeted for performance measurement is conducted. After completion of the performance measurement, the image of the guest VM for performance measurement 110 copied to the host server targeted for performance measurement is discarded from the host server.

In addition, in performance measurement when the virtualization system 1 is built (when operation starts), as illustrated in FIG. 1, all of the host servers 20A, 20B are targeted for performance measurement. Since no guest VM is set on the host servers 20A, 20B at this point of time, a process to move the guest VM to another host server is not performed.

In the virtualization system 1 illustrated in FIG. 1, first, an image of the guest VM for performance measurement 110 is copied to each of the host servers 20A, 20B (see arrows A1, A2). Then, activating the guest VM for performance measurement 110 on each of the host servers 20A, 20B, performance measurement of each of the host servers 20A, 20B is conducted, a result of the performance measurement for each host server is saved in the storage unit 10b (benchmark performance value table T4 to be described below). Then, the image of the guest VM for performance measurement 110 is discarded from each of the host servers 20A, 20B and operation of the virtualization system 1 is started.

A performance value measured when the virtualization system 1 is built (when operation starts) may be hereinafter referred to as an initial performance value. In addition, a performance value measured at ay timing after measurement of an initial performance value may be referred to as an in-operation performance value. Furthermore, a performance value measured after the host servers 20A, 20B are rebuilt may be referred to as a post-rebuilding performance value.

[1-2] VM Rotation Procedure and Measurement Procedure of an in-Operation Performance Value

After an initial performance value is measured and then operation of the virtualization system 1 is started, as described above, an operating guest VM 120 other than the guest VM for performance measurement is moved from a host server targeted for performance measurement to another host server, every time performance measurement timing comes, as illustrated in FIGS. 2A to 2D. More specifically, when there are multiple virtualization system hosts 20A, 20B, the operation management server 10 automatically moves an operating guest VM 120 operating on a host server targeted for performance measurement to another host server.

Then, in this embodiment, performance measurement and operation of the operating guest VM 120 in the multiple host servers 20A, 20B are rotated and performance (change in performance) on each server is continuously measured and recorded, without stopping operation of the virtualization system 1. The virtualization system 1 for performing continued operation while conducting performance measurement includes at least one operation management server 10, and n+1 host servers (20A, 20B), where n is the number of host servers used in continuous operation and an integer of 1 or more. When n is 0, the number of host servers is 1, continued operation is not allowed when performance of the host server is measured, and the virtualization system 1 enters an operation stopped state. Therefore, n=1 in the virtualization system 1 of a minimal configuration, and as illustrated in FIGS. 1 to 3, the virtualization system 1 includes one operation management server 10 and two host servers 20A, 20B.

The VM rotation procedure and the measurement procedure of an in-operation performance value in the virtualization system 1 with the minimal configuration according to this embodiment are described with reference to FIGS. 2A to 2D.

As illustrated in FIGS. 2A to 2D, every time performance measurement timing comes, all operating guest VMs 120 are moved (rotated) between the host servers 20A, 20B. The operating guest VM 120 is moved, and the host server 20A or 20B that has no operating guest VM 120 is targeted for performance measurement. The guest VM for performance measurement 110 is copied to the host server targeted for performance measurement, and performance measurement of the host server targeted for performance measurement is conducted. In this manner, a guest VM that moves (rotation) between the host servers 20A, 20B is only the operating guest VM 120, and the guest VM for performance measurement 110 is copied to a host server targeted for performance measurement from the operation management server 10 every time performance measurement timing comes.

For example, as illustrated in FIG. 2A, when performance measurement timing comes, all operating guest VMs 120 on the host B are moved from the host B to the host A (see arrow A11) and the host B is targeted for performance measurement. After this, as illustrated in FIG. 2B, a guest VM for performance measurement 110 is copied from the operation management server 10 to the host B, and performance measurement of the host B is then conducted (see arrow A12). A result of the performance measurement is saved in the operation management server 10 and used for deterioration judgment to be described below. After completion of the performance measurement, the guest VM for performance measurement 110 copied to the host B is discarded.

Then, when next performance measurement timing comes, as illustrated in FIG. 2C, all operating guest VMs 120 on the host A are moved from the host A to the host B (see arrow A13), and the host A is targeted for performance measurement. Then, as illustrated in FIG. 2D, the guest VM for performance measurement 110 is copied from the operation management server 10 to the host A, and performance measurement of the host A is conducted (see arrow A14). A result of the performance measurement is saved in the operation management server 10 and used for deterioration judgment to be described below. After completion of the performance measurement, the guest VM for performance measurement 110 copied to the host A is discarded.

Subsequently, in the virtualization system 1 of this embodiment, actions described FIGS. 2A to 2D are repeatedly performed unless it is judged that performance deterioration occurs, as described below.

[1-3] Rebuilding Procedure of a Host Server

In this embodiment, it is judged based on an initial performance value and an in-operation performance value measured as described above whether or not the performance of a host server is deteriorated. For example, for a host server for which the in-operation performance value deteriorates beyond a predetermined threshold value with respect to the initial performance value, it is determined that the host server includes a deterioration factor such as the items (b1) to (b4) as listed above, and the operation management server 10 automatically rebuilds the host server.

Rebuilding of a host server is performed, for example, as described below.

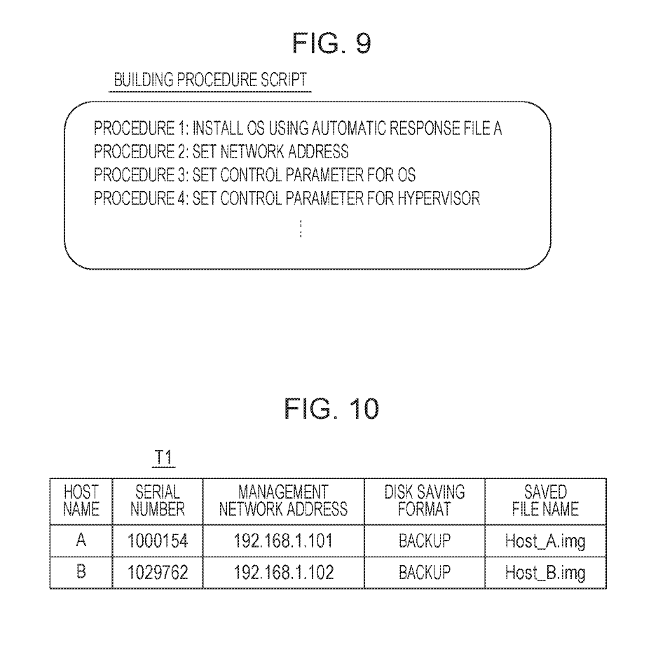

First, when the virtualization system 1 is built (when operation starts), a disk image (see FIG. 3, for example) in each host server is saved as a backup file in the operation management server 10 (storage unit 10b). Alternatively, a building procedure of each host server is described as a script (see FIG. 9, for example) and saved in the operation management server 10 (storage unit 10b). Both the backup file and the building procedure script may also be saved.

Then, for a certain host server, when an in-operation performance value deteriorates beyond a predetermined threshold with respect to an initial performance value, it is determined that performance deterioration has occurred on the certain host server. The certain host server for which it is determined that performance is deteriorated is rebuilt by the operation management server 10 by using the backup file saved when operation started or the building procedure script, as illustrated in FIG. 3.

FIG. 3 illustrates a case in which it is determined that performance is deteriorated in the host server 20A of the two host servers 20A, 20B. A disk image (backup file) of when the host server 20A is built and a building procedure script of the host server 20A are saved in the storage unit 10b of the operation management server 10. Then, in FIG. 3, the operation management server 10 rebuilds the host server 20A in which performance deterioration is detected, by copying the disk image at the time of building of the host server 20A to the host server 20A (see arrow A21).

Furthermore, in this embodiment, after rebuilding of the host server is completed, performance measurement of the host server after the rebuilding is conducted by using the guest VM for performance measurement 110. Then, based on a result of the performance measurement after rebuilding (post-rebuilding performance value) and the initial performance value, it is judged whether or not the performance of the host server after rebuilding is deteriorated. For example, when the post-rebuilding performance value is deteriorated beyond a predetermined threshold with respect to the initial performance value, the operation management server 10 determines that the host server has a failure and notifies a manager or the like accordingly.

### [2] Hardware Configuration of an Operation Management Server

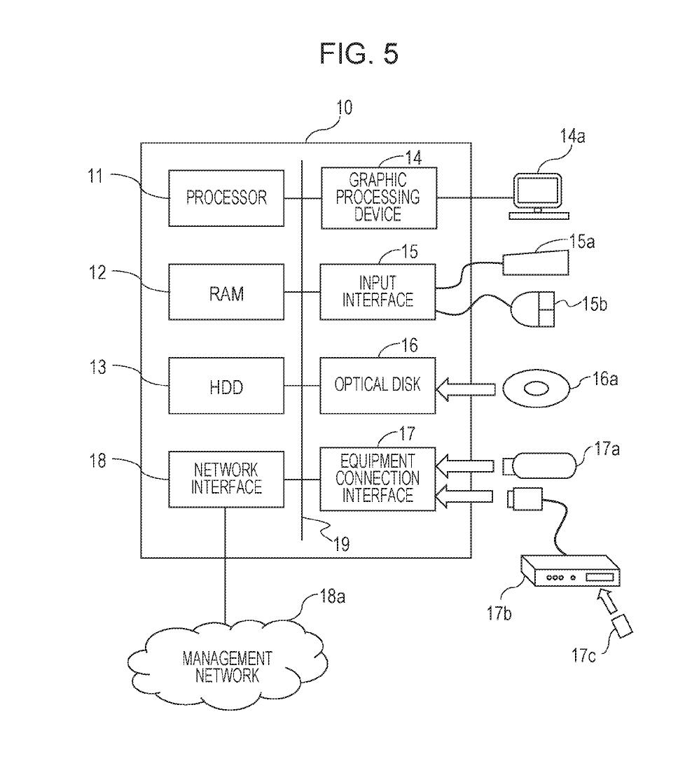

Next, a hardware configuration of an operation management server (management device, computer) 10 of this embodiment is described with reference to FIG. 5. FIG. 5 is a block diagram illustrating one example of the hardware configuration.

The operation management server 10 is configured as a general computer, and includes, as a component, a processor 11, a random access memory (RAM) 12, a hard disk drive (HDD) 13, a graphic processing device 14, an input interface 15, an optical drive device 16, a device connection interface 17, and a network interface 18. These components 11 to 18 are configured to be able to communicate with each other by way of a bus 19.

The processor (processing unit) 11 controls the entire operation management server 10. The processor 11 may be a multiprocessor. The processor 11 may be any one of, for example, a central processing unit (CPU), a micro processing unit (MPU), a digital signal processor (DSP), an application specific integrated circuit (ASIC), a programmable logic device (PLD), and a field programmable gate array (FPGA). The processor 11 may also be a combination of two or more elements of a CPU, an MPU, a DSP, an ASIC, a PLD, and an FPGA.

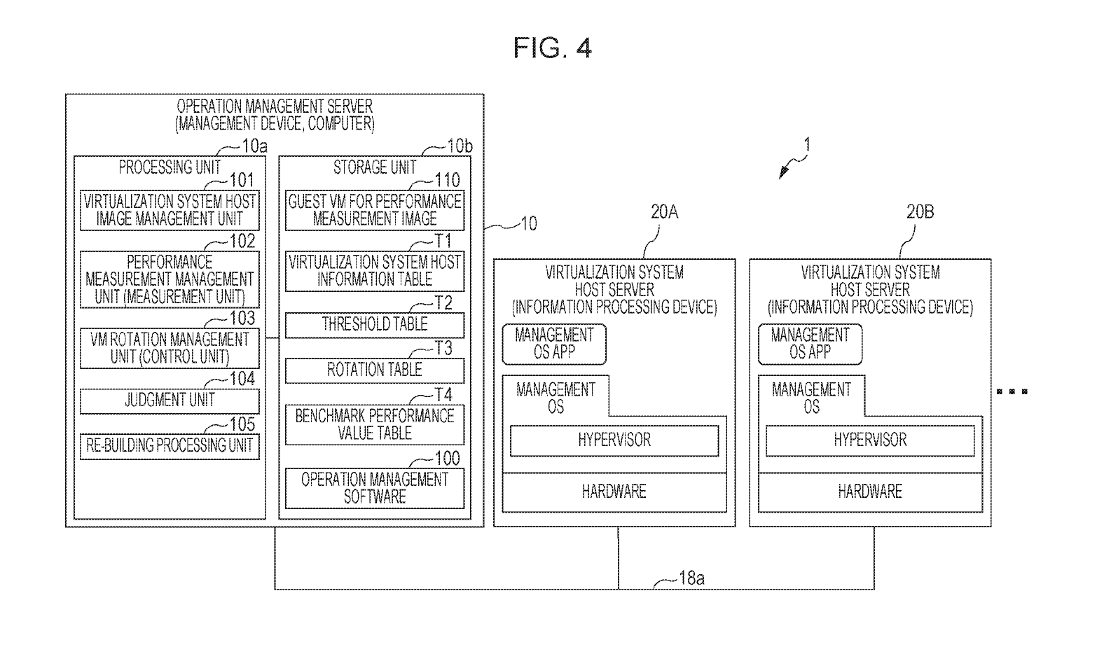

The RAM (storage unit) 12 is used as a main storage device of the operation management server 10. The RAM 12 temporarily stores at least a part of an OS program or an application program that the processor 11 is caused to execute. The RAM 12 also stores various types of data desirable for processing by the processor 11. An application program may include operation management software 100 (see FIG. 4) to be executed by the processor 11 to implement functions for the operation management server 10 to manage a host server (information processing device) in the virtualization system 1 of this embodiment.

The HDD (storage unit) 13 magnetically writes or reads data to or from a built-in disk. The HDD 13 is used as an auxiliary storage device of the operation management server 10. The HDD 13 stores an OS program, an application program, and various types of data. In addition, a solid state device (SSD) such as a flash memory or the like may also be used as an auxiliary storage device.

A monitor 14a is connected to the graphic processing device 14. The graphic processing device 14 displays an image on the screen of the monitor 14a according to an instruction from the processor 11. The monitor 14a may include a display device using a cathode ray tube (CRT) or a liquid crystal display or the like.

A keyboard 15a and a mouse 15b are connected to the input interface 15. The input interface 15 transmits to the processor 11 a signal sent from the keyboard 15a or the mouse 15b. Note that the mouse 15b is one example of a pointing device and other pointing devices may also be used. The other pointing devices include a touch panel, a tablet, a touch pad, a track ball, or the like.

The optical drive device 16 utilizes laser beam or the like to write or read data recorded in an optical disk 16a. The optical disk 16a is a portable, non-transitory recording medium in which data is readably recorded by reflection of light. The optical disk 16a includes a digital versatile disc (DVD), a DVD-RAM, a compact disc read only memory (CD-ROM), a CD-R (Recordable)/RW (ReWritable), or the like.

The device connection interface 17 is a communication interface to connect a peripheral device to the operation management server 10. For example, a memory device 17a or a memory reader/writer 17b may be connected to the device connection interface 17. The memory device 17a is a non-transitory recording medium equipped with the function to communicate with the device connection interface 17, such as a Universal Serial Bus (USB) memory, or the like. The memory reader/writer 17b writes data to a memory card 17c or reads data from the memory card 17c. The memory card 17c is a card-type non-transitory recording medium.

The network interface 18 is connected to a network 18a. The network interface 18 transmits and receives data to/from other computers or communication devices by way of the management network 18a. In this embodiment, the operation management server 10 is communicatively connected to host servers (information processing devices) 20A to 20C (see FIGS. 4, 8, and 15) to be managed, by way of the management network 18a.

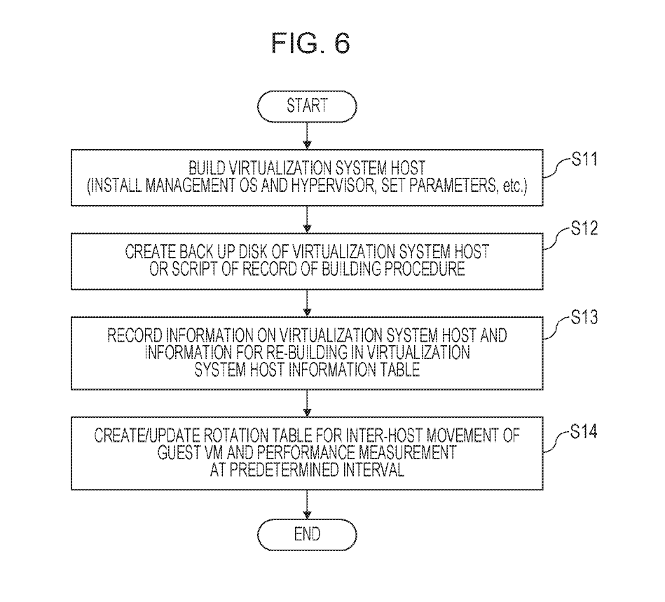

The operation management server (computer) 10 having the hardware configuration as described above enables implementation of a host server management function of this embodiment to be described below with reference to FIGS. 6 to 20.

Note that the computer 10 implements the host server management function of this embodiment by executing a program recorded in a computer readable non-transitory recording medium, for example. A program describing content of processing that the computer 10 is caused to execute may be stored in various recording media. For example, the program that the computer 10 is caused to execute may be stored in the HDD 13. The processor 11 loads at least a part of the program in the HDD 13 to the RAM 12 and executes the loaded program.

In addition, the program that the computer 10 (processor 11) is caused to execute may be recorded in such a portable, non-transitory recording medium as the optical disk 16a, the memory device 17a, the memory card 17c or the like. A program stored in the portable recording medium becomes executable after being installed in the HDD 13 under the control of the processor 11, for example. In addition, the processor 11 may read the program directly from the portable recoding medium and execute the program.

### [3] Functional Configuration of a Virtualization System Including an Operation Management Server

Next, a functional configuration of a virtualization system 1 including an operation management server 10 of this embodiment is described with reference to FIG. 4. FIG. 4 is a block diagram illustrating one example of the functional configuration.

The operation management server 10 has at least functions as a processing unit 10a and a storage unit 10b, as illustrated in FIG. 4, in order to manage multiple virtualization system host servers (first information processing device, second information processing device) 20A, 20B included in the virtualization system 1.

The processing unit 10a is, for example, a processor 11 illustrated in FIG. 5, and functions as a virtualization system host image management unit 101, a performance measurement management unit 102, a VM rotation management unit 103, a judgment unit 104, and a rebuilding processing unit 105, by executing the operation management software 100.

The storage unit 10b is, for example, the RAM 12 or the HDD 13, as illustrated in FIG. 5, and stores and saves various types of information for implementing the host server management function. The various types of information includes a virtualization system host information table T1, a threshold table T2, a rotation table T3, a benchmark performance value table T4 or the like, in addition to the operation management software 100 and the guest VM for performance measurement 110 as described above.

The virtualization system host image management unit 101 records in the storage unit 10b (virtualization system host information table T1) information on every virtualization system host when the virtualization system 1 is built and manages the information. Furthermore, the virtualization system host image management unit 101 records in the storage unit 10b and manages a copy of a disk image or a building procedure script of every virtualization system host, as information to be used in rebuilding, when the virtualization system 1 is built.

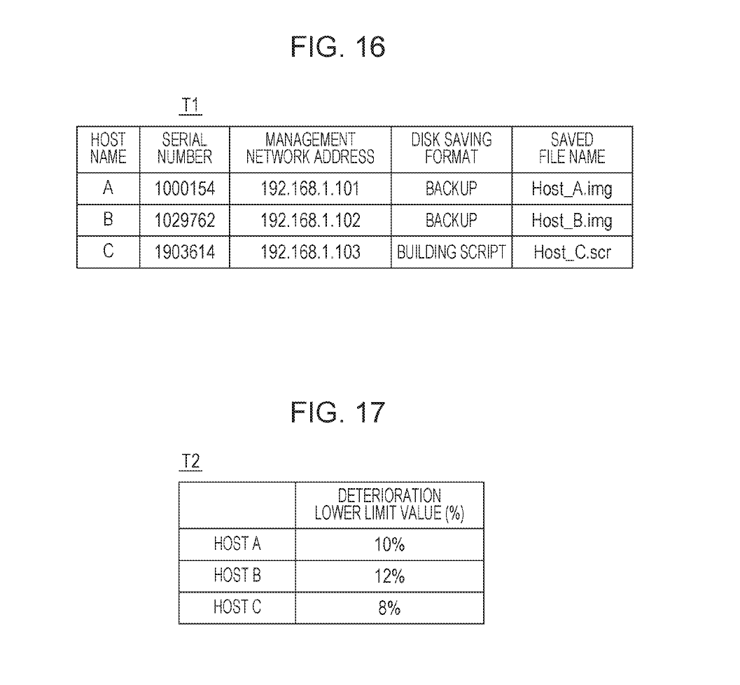

In the virtualization system host information table T1 are recorded a “host name”, a “serial number”, a “management network address”, a “disk saving format”, “saved file name” or the like of each host server, as described below with reference to FIG. 10 or FIG. 16, for example.

Now, when a copy of a disk image is saved as information for rebuilding in the storage unit 10b, a “backup” is recorded as the “disk saving format” (see FIG. 10). On the other hand, when a building procedure script is saved as information for rebuilding in the storage unit 10b, a “building script” is recorded as the “disk saving format” (see FIG. 16). In addition, information (file name) specifying a file in which the copy of the disk image or the building procedure script is saved in the storage unit 10b is recorded as the “saved file name” (see FIGS. 10 and 16). The information (file name) may be linked to the file in which the copy of the disk image or the building procedure script is saved.

The performance measurement management unit 102 measures for every virtualization system host an initial performance value at the time of building, an in-operation performance value, a post-rebuilding performance value, or the like and manages the measured performance values. More specifically, the performance measurement management unit 102 functions as a measurement unit configured to conduct performance measurement of a host server targeted for performance measurement by moving an operating guest VM 120 set on the host server targeted for performance measurement from the host server targeted for the performance measurement to another host server.

Then, the performance measurement management unit 102 copies an image of the guest VM for performance measurement 110 to the host server targeted for performance measurement by way of the management network 18a, as described earlier with reference to FIG. 1. Then, the performance measurement management unit 102 measures an initial performance value at the time of building, an in-operation performance value, a post-building performance value or the like by causing the host server targeted for performance measurement to execute the guest VM for performance measurement 110. After completion of performance measurement, the performance measurement management unit 102 discards the guest VM for performance measurement 110 from the host server targeted for performance measurement.

The performance measurement management unit 102 records in the storage unit 10b (benchmark performance value table T4) and manages the initial performance value at the time of building, the in-operation performance value, the post-building performance value or the like. As described below with reference to FIGS. 13, 14, 19, and 20, for example, “execution time” of performance measurement and a “performance value” measured at the execution time are associated and recorded for every virtualization system host in the benchmark performance value table T4.

The VM rotation management unit 103 manages, among virtualization system hosts, in what host server the operating guest VM 120 is to be activated and in what host server performance measurement is to be conducted. More specifically, as described earlier with reference to FIGS. 2A to 2D, the VM rotation management unit 103 functions as a control unit configured to perform movement control to move the operating guest VM 120 set on the host server targeted for performance measurement to another host server.

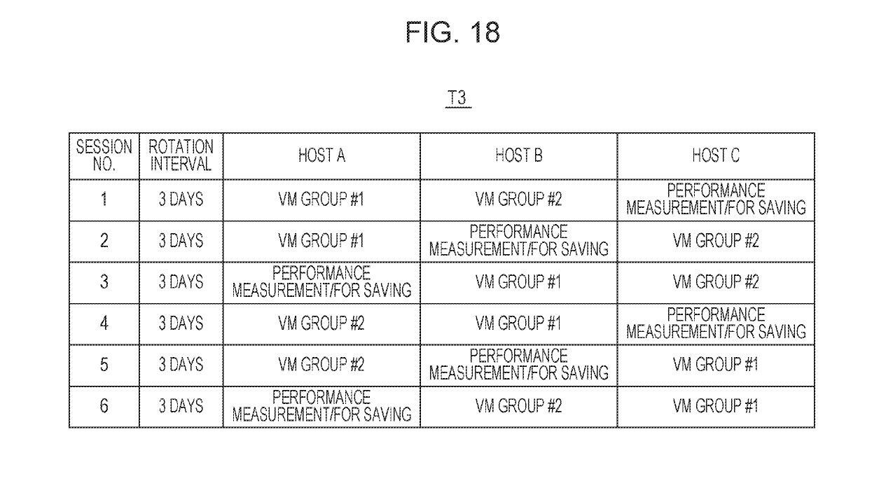

Then, the VM rotation management unit 103 performs the movement control described above based on the rotation table T3 stored in advance in the storage unit 10b. As described below with reference to FIG. 12 or FIG. 18, for example, the rotation table T3 records a “rotation interval” and a “state” of each host server at the “rotation interval” for each of two or more “session numbers”. Here, as the “state” of the host server activating the operating guest VM 120, an “operation VM” (see FIG. 12) or a VM group number (see FIG. 18) activated by the host server are recorded. In addition, “performance measurement/for saving” is recorded as the “state” of a host server which is to be used as a saving server on which no operating guest VM 120 is set after conducting performance measurement.

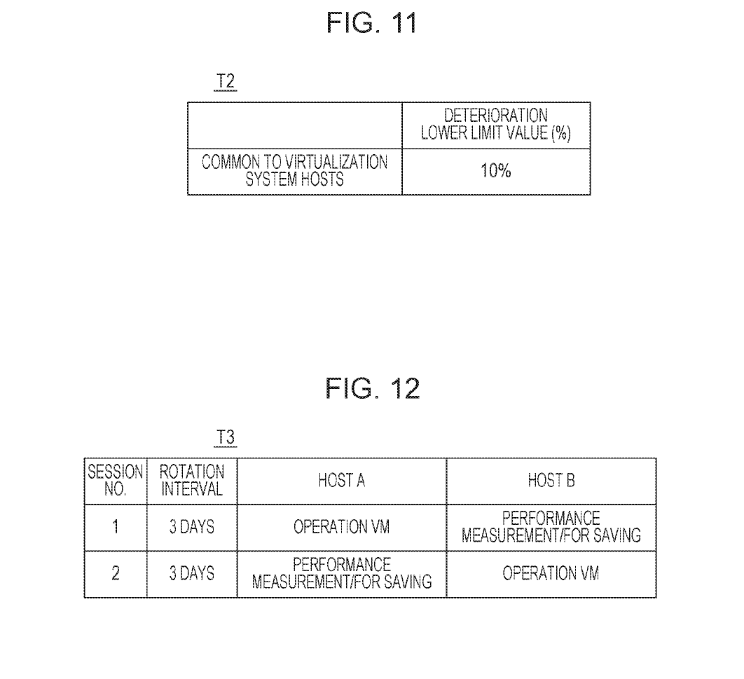

The judgment unit 104 refers to the benchmark performance value table T4, and judges whether or not the performance of the host server targeted for performance measurement is deteriorated, based on an initial performance value and a result of performance measurement (in-operation performance value) of a host server targeted for performance measurement. As described earlier, the judgment unit 104 determines that a host server, for which an in-operation performance value is deteriorated beyond a predetermined threshold with respect to an initial performance value, includes the deterioration factor such as the items (b1) to (b4) listed above. The predetermined threshold is set in advance as a deterioration lower limit value (percentage; %) in the threshold table T2, as described below with reference to FIG. 11 or FIG. 17, for example. The judgment unit 104 calculates a difference between the initial performance value and the in-operation performance value with the following expression [1] to compare the calculated difference with the deterioration lower limit value in the threshold table T2:

[Difference]={([Initial performance value]−[In-operation performance value])/[Initial performance value]}×100% [1]

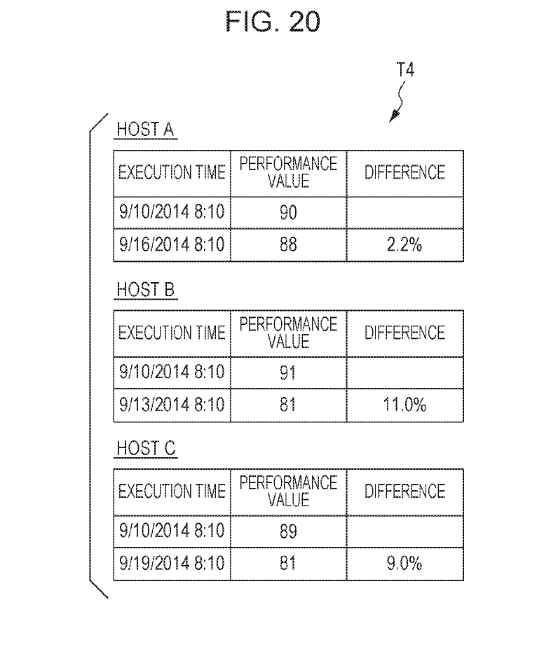

When the difference calculated as described above exceeds the deterioration lower limit value in the threshold table T2, the judgment unit 104 determines that performance deterioration (deterioration factor) occurs in the host server targeted for performance measurement. In addition, the calculated difference is recorded and saved in the benchmark performance value table T4, as described below with reference to FIGS. 14 and 20, for example.

When the judgment unit 104 judges that the host server targeted for performance measurement is deteriorated, the rebuilding processing unit 105 automatically rebuilds the host server, as described earlier with reference to FIG. 3. Then, the rebuilding processing unit 105 uses a disk image (backup file) of the host server or a building procedure script, saved by the virtualization system host image management unit 101 when the virtualization system 1 is built. Now, rebuilding of the host server is a process to initialize the host server to restore the host server to a state (initial state) of when the virtualization system 1 is built (when operation starts).

After rebuilding of the host server is completed, the performance measurement management unit 102 conducts performance measurement of the host server after rebuilding and measures a post-rebuilding performance value. Then, the judgment unit 104 refers to the benchmark performance value table T4, and judges whether or not the performance of the host server after rebuilding is deteriorated, based on the initial performance value and the measured post-rebuilding performance value of the host server.

In the case, the judgment unit 104 calculates a difference between the initial performance value and the post-rebuilding performance value with an expression similar to the above-mentioned expression [1] and compares the calculated difference with the deterioration lower limit value in the threshold table T2. When the calculated difference exceeds the deterioration lower limit value in the threshold table T2 as described above, the judgment unit 104 determines that some failure occurs in the host server because the host server is in a performance deteriorated state even immediately after the rebuilding, and notifies a manager or the like accordingly. Note that the calculated difference is recorded and saved in the benchmark performance value table T4.

### [4] Action of the Operation Management Server

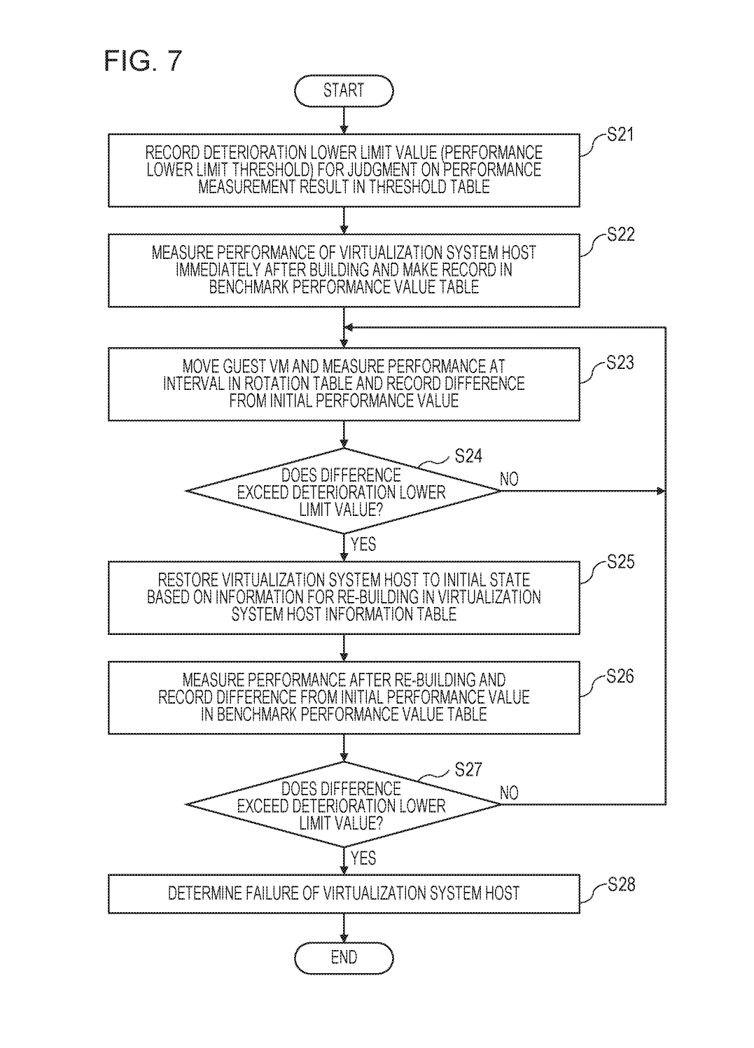

Action of the operation management server 10 illustrated in FIG. 4 is described hereinafter with reference to FIGS. 6 and 7.

[4-1] Virtualization System Host Server Initial Building Process

An initial building process of virtualization system host servers 20A, 20B by the operation management server 10 is described, following a flow chart (steps S11 to S14) illustrated in FIG. 6.

First, management OS, a management OS app, a hypervisor or the like being installed in each of the host servers 20A, 20B which constitute the virtualization system 1 and control parameters of the management OS or the hypervisor or the like being set, the host servers 20A, 20B are each built (step S11). Such installation or parameter setting may be directly performed on each of the host servers 20A, 20B, or may be performed on each of the host servers 20A, 20B from the operation management server 10.

After each of the host servers 20A, 20B is built, the virtualization system host image management unit 101 creates a copy of a disk image (backup file) or a script recording a building procedure for every host server (step S12).

In addition, for every host server, the virtualization system host image management unit 101 records information of each host server or rebuilding information (backup file or a building procedure script) to be used in rebuilding, in the virtualization system host information table T1 (step S13).

Then, in the operation management server 10 is created or updated (step S14) a rotation table T3 for performing movement of an operating guest VM 120 between host servers and performance measurement of a host server targeted for performance measurement at a predetermined interval (arbitrary period of time). Then, the initial building process of the host servers 20A, 20B completes.

[4-2] Performance Measurement, Threshold Judgment, and Rebuilding Process During Operation

Then, performance measurement, threshold judgment, and rebuilding process by the operation management server 10 during operation are described following the flow chart (steps S21 to S28) illustrated in FIG. 7.

First, in the operation management server 10, a deterioration lower limit value (performance lower limit value) used for deterioration judgment of a performance measurement result by the judgment unit 104 is recorded in a threshold table T2 (step S21). A specific example of a deterioration lower limit value is described below with reference to FIG. 11 or FIG. 17. Note that processing in step S21 may be performed in the initial building process illustrated in FIG. 6.

Then, as illustrated in FIG. 1, the performance measurement management unit 102 conducts performance measurement to acquire an initial performance value by copying and activating a guest VM for performance measurement 110 for every virtualization system host immediately after being built. The acquired initial performance value is recorded in a benchmark performance value table T4 (step S22). After the performance measurement, the guest VM for performance measurement 110 copied to each host server is discarded.

After this, the virtualization system is in an operation state. In the operation state, one of host servers that constitute the virtualization system 1 is used as a server for saving, and no guest VM 120 is set on the one host server during a predetermined rotation interval. Then, when the rotation interval elapses, according to the rotation table T3, a VM rotation management unit 103 moves an operating guest VM 120 on a host server targeted for performance measurement to the host server for saving, as illustrated in FIGS. 2A to 2D. The performance measurement management unit 102 conducts performance measurement to acquire an in-operation performance value by copying the guest VM for performance measurement 110 to the host server targeted for performance measurement, from which the operating guest VM 120 has been moved, and activating the guest VM for performance measurement 110. The acquired in-operation performance value is recorded in the benchmark performance value table T4. After the performance measurement, the guest VM for performance measurement 110 copied to the host server targeted for performance measurement is discarded. In addition, the judgment unit 104 calculates the above-mentioned difference, with the above-mentioned expression [1], based on the initial performance value and the in-operation performance value, and records the difference in the benchmark performance value table T4 (step S23).

The judgment unit 104 judges whether or not the difference calculated as described above exceeds the deterioration lower limit value in the threshold table T2 (step S24). When the difference does not exceed the deterioration lower limit value (NO route in step S24), the operation management server 10 returns to processing of step S23 and performs processing of a next rotation interval.

On the other hand, when the difference exceeds the deterioration lower limit value (YES route in step S24), the judgment unit 104 determines that performance deterioration (deterioration factor) has occurred in the host server targeted for performance measurement. Then, the rebuilding processing unit 105 initializes the host server and restores the host server to an initial state (initial configuration) of when the virtualization system 1 is built, by rebuilding the host server using information for rebuilding in the virtualization system host information table T1 (step S25).

After the host server is rebuilt, the performance measurement management unit 102 conducts performance measurement to acquire a post-rebuilding performance value, by copying the guest VM for performance measurement 110 to the host server after the rebuilding and activating the copied guest VM for performance measurement 110. The acquired post-rebuilding performance value is recorded in the benchmark performance value table T4. After the performance measurement, the guest VM for performance measurement 110 copied to the host server after the rebuilding is discarded. Furthermore, the judgment unit 104 calculates the above-mentioned difference based on the initial performance value and the post-rebuilding performance value and records the difference in the benchmark performance value table T4 (step S26).

The judgment unit 104 judges whether or not the difference calculated after rebuilding exceeds the deterioration lower limit value in the threshold table T2 (step S27). When the difference does not exceed the deterioration lower limit value (NO route in step S27), the operation management server 10 returns to processing of step S23 and performs processing of a next rotation interval.

On the other hand, when the difference after rebuilding exceeds the deterioration lower limit value (YES route in step S27), the judgment unit 104 determines that a failure (abnormality) has occurred in the host server (step S28) and notifies a manager or the like accordingly.

### [5] Examples of a Virtualization System

### [5-1] First Example

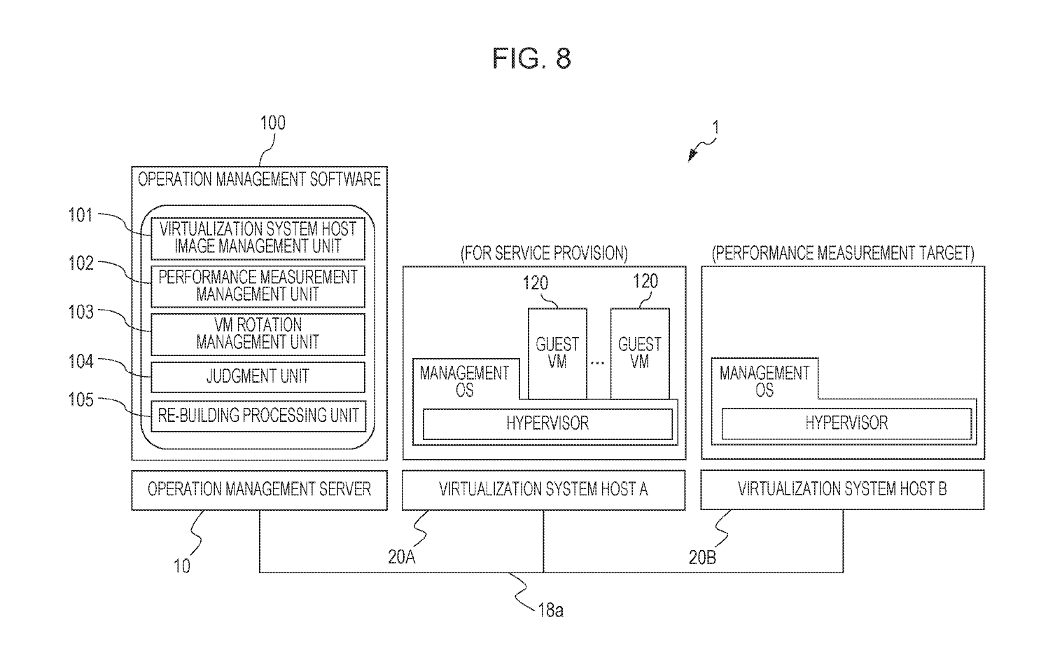

A first example of a virtualization system 1 of this embodiment is described hereinafter with reference to FIGS. 8 to 14, as well as FIGS. 6 and 7 referred in the above item [4].

FIG. 8 is a block diagram illustrating an in-operation configuration of a first example of the virtualization system 1 of this embodiment. As illustrated in FIG. 8, the virtualization system 1 of the first embodiment includes one operation management server 10, and two host servers 20A, 20B. In the virtualization system 1 of the first embodiment illustrated in FIG. 8, the host server 20A is for provision of services and multiple guest VMs 120 are set and activated in the host server 20A. In addition, in the virtualization system 1 of the first example illustrated in FIG. 8, the host server 20B is targeted for performance measurement, and no guest VM 120 other than the guest VM for performance measurement 110 is set and driven in the host server 20B even during operation. The host server 20B is used as a host server for saving, to which the operating guest VM (operation VM) 120 is moved from the host server 20A at next rotation timing after performance measurement is completed.

First, given the first example, the following processes (c1) to (c4) are performed.

(c1) A building process of the two host servers 20A, 20B is performed. Then, management OS, a management OS app, a hypervisor, or the like are installed in each of the host servers 20A, 20B, and control parameters, or the like of the management OS or the hypervisor are set (see step S11 of FIG. 6).

(c2) After each of the host servers 20A, 20B is built, the virtualization system host image management unit 101 creates, as information for rebuilding, a backup file, which is a copy of a disk image, or a file including a script in which a building procedure is recorded (see S12 of FIG. 6), for every host server. FIG. 9 illustrates one example of the building procedure script of the host servers 20A, 20B. In the building procedure script illustrated in FIG. 9, a procedure performed when each host server is built is described in the order of performance, and a rebuilding processing unit 105 or a manager or the like may rebuild each host server by sequentially performing the procedure described in the building procedure script.

(c3) The virtualization system host image management unit 101 records, for each of the host servers 20A, 20B, information on each host server or the information for rebuilding, in the virtualization system host information table T1 (see step S13 of FIG. 6). Now, FIG. 10 illustrates one example of the virtualization system host information table T1 which corresponds to the virtualization system 1 of the first example illustrated in FIG. 8. In FIG. 10, a serial number “1000154”, an Internet Protocol (IP) address of a management network 18a “192.168.1.101”, a disk saving format “backup”, and a saved file name “Host_A.img” are recorded as information on the host server 20A having a host name A. Similarly, a serial number “1029762”, an Internet Protocol (IP) address of the management network 18a “192.168.1.102”, the disk saving format “backup”, and a saved file name “Host_B.img” are recorded as information on the host server 20B having a host name B.

(c4) The operation management server 10 creates a rotation table T3 for performing movement of the operating guest VM 120 between host servers and performance measurement of a host server targeted for performance measurement at a predetermined rotation interval (see step S14 of FIG. 6). Now, FIG. 12 illustrates one example of the rotation table T3 set for the virtualization system 1 of the first embodiment illustrated in FIG. 8. A rotation interval “3 days” is set in Session No. 1 of FIG. 12, the “host A” is set at a state to activate the operation VM (guest VM 120), and the “host B” is set at performance measurement/for saving. In addition, in Session No. 2 of FIG. 12, a rotation interval “3 days” is set, the “host A” is set at performance measurement/for saving, and the “host B” is set at a state to activate the operation VM (guest VM 120). The VM rotation management unit 103 repeatedly performing movement control according to Session Nos. 1 and 2 based on the rotation table T3 illustrated in FIG. 12, the host A and the host B are each switched to the guest VM operation state or the performance measurement target every three days. More specifically, unless it is judged that performance deterioration occurs in the virtualization system 1 illustrated in FIG. 8, actions illustrated in FIGS. 2A to 2D are repeatedly performed.

Then, the following processes (d1) to (d6) are performed in the first example.

(d1) In the operation management server 10, a deterioration lower limit value used for deterioration judgment on a performance measurement result by the judgment unit 104 is recorded in the threshold table T2 (see step S21 of FIG. 7). A deterioration lower limit value is a value indicating a lower limit value of a difference (deterioration percent) of an in-operation performance value to an initial performance value acquired immediately after building. Now, FIG. 11 illustrates one example of the threshold table T2 set for the virtualization system 1 of the first example illustrated in FIG. 8. Although as a deterioration lower limit value, a different value may be set for each host server as described below with reference to FIG. 17, a value of 10% which is common to all host servers 20A, 20B is set in the threshold table T2 illustrated in FIG. 11.

(d2) Immediately after building of the virtualization system 1, a guest VM for performance measurement 110 being copied (cloning) to each of the host servers 20A, 20B and activated, performance measurement is conducted without setting any guest VM other than the guest VM for performance measurement 110. With this, an initial performance value is acquired for each of the host servers 20A, 20B in a state that conditions of every measurement are identical, and is recorded in the benchmark performance value table T4 (see step S22 in FIG. 7). After performance measurement, the guest VM for performance measurement 110 copied to each of the host servers 20A, 20B is discarded. Here, FIG. 13 illustrates one example of the benchmark performance value table T4 in which an initial performance value measured for the virtualization system 1 of the first example illustrated in FIG. 8 is recorded. In FIG. 13, it is recorded that an initial performance value of 90 was measured at execution time Sep. 10, 2014 8:10 of performance measurement for the “host A” and that an initial performance value of 91 was measured at execution time Sep. 10, 2014 8:10 of performance measurement for the “host B”.

(d3) After the processing (d2) described above is performed, the virtualization system 1 is in an operation state. In the operation state, in the virtualization system 1 illustrated in FIG. 8, an operating guest VM 120 is set and activated/operated on one host server. In the case, the other host server is for saving during performance measurement of the one host server and no operating guest VM 120 is set thereon. Then, an operating guest VM 120 on the one host server is moved to the other host server at a rotation interval set in the rotation table T3 (see step S23 of FIG. 7). In this case, the VM rotation management unit 103 starts with processing of Session No. 1 of the rotation table T3 illustrated in FIG. 12, shifts to processing of the next Session No. 2 at a rotation interval (3 days), and further shifts to the processing of Session No. 1 at the rotation interval (3 days). When shifting from the processing of Session No. 1 to the processing of Session No. 2, the VM rotation management unit 103 conducts performance measurement at the host A that does not have the guest VM 120 after moving all operation VMs (operating guest VM) 120 on the host A to the host B. To the contrary, when shifting from the processing of Session No. 2 to the processing of Session No. 1, the VM rotation management unit 103 conducts performance measurement at the host B that does not have the guest VM 120 after shifting all operation VMs 120 on the host B to the host A.

(d4) The performance measurement management unit 102 conducts performance measurement to acquire an in-operation performance value by copying the guest VM for performance measurement 110 to the host server 20A or 20B targeted for performance measurement, and by activating the copied guest VM for performance measurement 110. The acquired in-operation performance value is recorded in the benchmark performance value table T4. After the performance measurement, the guest VM for performance measurement 110 copied to the host server targeted for performance measurement is discarded. Furthermore, the judgment unit 104 calculates the above-mentioned difference, with the above-mentioned expression [1], based on the initial performance value and the in-operation performance value, and records the difference in the benchmark performance value table T4 (see step S23 of FIG. 7). Now, FIG. 14 illustrates one example of the benchmark performance value table T4 in which the in-operation performance value measured for the virtualization system 1 of the first example illustrated in FIG. 8 is recorded. In FIG. 14, for the “host A”, the in-operation performance value of 88 was measured at time Sep. 13, 2014 8:10 three days after the initial performance value was measured, the value of 2.2%, which corresponds to the difference between the in-operation performance value of 88 and the initial performance value of 90, is calculated with the above-mentioned expression [1], and the in-operation performance value of 88 and the difference of 2.2% are additionally recorded. In addition, in FIG. 14, for the “host B”, the in-operation performance value of 81 was measured at time Sep. 16, 2014 8:10 three days after the performance measurement of the host A was conducted, the value 11.0%, which corresponds to the difference between the in-operation performance value of 81 and the initial performance value of 91, is calculated with the above-mentioned expression [1], and the in-operation performance value of 81 and the difference of 11.0% are additionally recorded.

(d5) The judgment unit 104 judges whether or not the difference recorded in the benchmark performance value table T4 exceeds the deterioration lower limit value of 10% in the threshold table T2 (see step S24 of FIG. 7). Since the difference of 2.2% between the in-operation performance value of 88 measured at time Sep. 13, 2014 8:10 for the host A and the initial performance value of 90 does not exceed the deterioration lower limit value of 10%, processing of a next session number is performed. On the other hand, since the difference of 11.0% between the in-operation performance value of 81 measured at time Sep. 16, 2014 8:10 for the host B and the initial performance value of 90 exceeds the deterioration lower limit value of 10%, the rebuilding processing unit 105, the performance measurement management unit 102, and the judgment unit 104 performs the following process (d6) on the host B.

(d6) The rebuilding processing unit 105 initializes a host B to restore the host B to an initial state (initial configuration) of when the virtualization system 1 is built by using information for rebuilding of the host B in the virtualization system host information table T1 and rebuilding the host B (see step S25 of FIG. 7). After the host B is rebuilt, the performance measurement management unit 102 conducts performance measurement to acquire a post-rebuilding performance value by copying the guest VM for performance measurement 110 to the host B after rebuilding, and by activating the copied guest VM for performance measurement 110. The acquired post-rebuilding performance value is recorded in the benchmark performance value table T4. After the performance measurement, the guest VM for performance measurement 110 copied to the host B after rebuilding is discarded. Furthermore, the judgment unit 104 calculates a difference based on the initial performance value and the post-rebuilding performance value by using an expression similar to the above-mentioned expression [1], and records the difference in the benchmark performance value table T4 (see step S26 of FIG. 7). Then, the judgment unit 104 judges whether or not the difference calculated after rebuilding exceeds the deterioration lower limit value in the threshold table T2 (see step S27 of FIG. 7). When the difference does not exceed the deterioration lower limit value, the operation management server 10 returns to processing of step S23, and performs processing of a next rotation interval. On the other hand, when the difference after rebuilding exceeds the deterioration lower limit value, the judgment unit 104 determines that some failure (abnormality) has occurred in the host B (see step S28 of FIG. 7) and notifies a manager or the like accordingly.

### [5-2] Second Embodiment

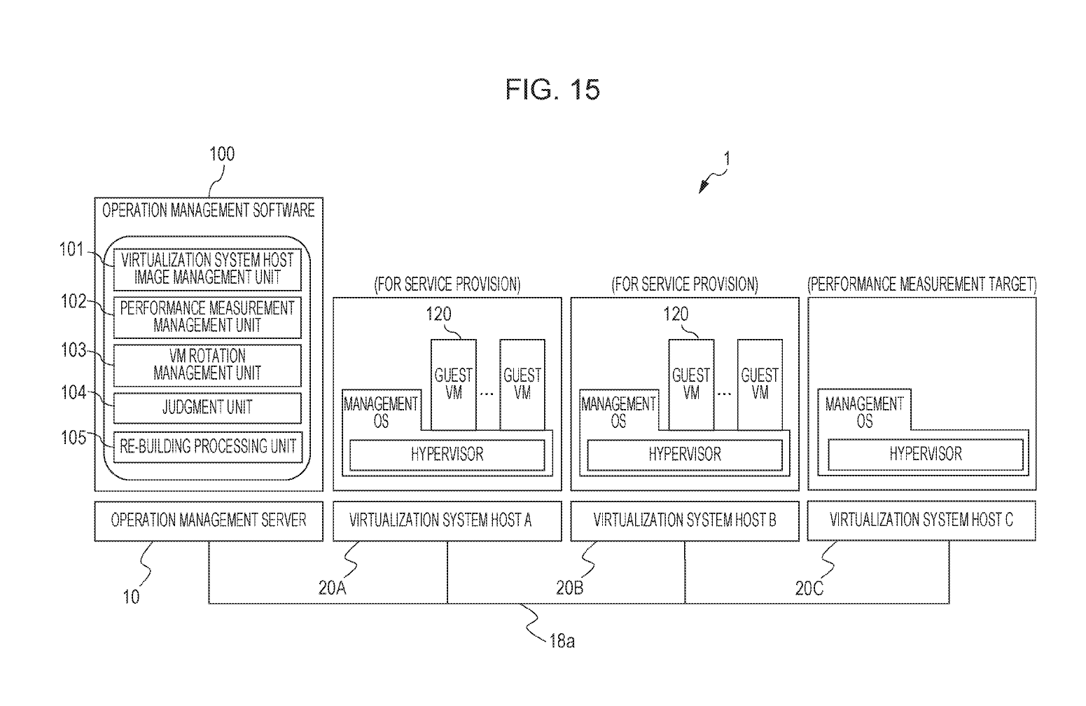

A second example of the virtualization system 1 of this embodiment is described with reference to FIGS. 15 to 20.

FIG. 15 is a block diagram illustrating an in-operation configuration of a second example of the virtualization system 1 of this embodiment. As illustrated in FIG. 15, the virtualization system 1 of the second example includes one operation management server 10 and three host servers 20A, 20B, and 20C. In the virtualization system 1 of the second example illustrated in FIG. 15, the host servers 20A, 20B are for provision of service and multiple guest VMs 120 are set and activated in each of the host servers 20A, 20B. In addition, in the virtualization system 1 of the second example illustrated in FIG. 15, the host server 20C is targeted for performance measurement, and no guest VM 120 other than the guest VM for performance measurement 110 is set and driven in the host server 20C even during operation. After the performance measurement is completed, the host server 20C is used as a host server for saving, to which the operating guest VM (operation VM) 120 is moved from the host server 20B at next rotation timing.

First, given the second example, the following processes (e1) to (e4) are performed.

(e1) A building process of the three host servers 20A to 20C is performed. In this case, management OS, a management OS app, a hypervisor, or the like are installed in each of the host servers 20A to 20C, and control parameters, or the like of the management OS or the hypervisor are set (see step S11 of FIG. 6).

(e2) After each of the host servers 20A to 20C is built, the virtualization system host image management unit 101 creates, as information for rebuilding, a backup file, which is a copy of a disk image, or a file including a script (see the above process (c2) and FIG. 9) in which a building procedure is recorded, for each of host servers (see S12 of FIG. 6).

(e3) The virtualization system host image management unit 101 records, for each of the host servers 20A to 20C, information on each host server or the information for rebuilding, in the virtualization system host information table T1 (see step S13 of FIG. 6). Now, FIG. 16 illustrates one example of the virtualization system host information table T1 which corresponds to the virtualization system 1 of the second example illustrated in FIG. 15. In FIG. 16, in addition to information of the host servers 20A, 20B similar to FIG. 10, a serial number “1903614”, an Internet protocol (IP) address of a management network 18a “192.168.1.103”, a disk saving format “backup”, and a saved file name “Host_C.scr” are recorded as information on the host server 20C having a host name C.

(e4) The operation management server 10 creates a rotation table T3 for performing movement of the operating guest VM 120 between host servers and performance measurement of a host server targeted for performance measurement at a predetermined rotation interval (see step S14 of FIG. 6). Now, FIG. 18 illustrates one example of the rotation table T3 set for the virtualization system 1 of the second embodiment illustrated in FIG. 15. In FIG. 18, two of the three host servers 20A to 20C activate the guest VM 120, and the remaining one host server is used as a host server for saving of a guest VM at the time of next performance measurement after performance measurement is conducted. Multiple guest VMs 120 activated on each of the two host servers are managed in groups for every host. Then, multiple guest VMs 120 operating on one host server of the two host servers are described as a VM group #1, and multiple guest VMs 120 operating on the other host server as a VM group #2. A rotation interval “3 days” is set in Session No. 1 of FIG. 18, the “host A” and the “host B” are set in states to activate the VM groups #1, and #2, respectively, and the “host C” is set at performance measurement/for saving. Subsequently, in the rotation table T3 illustrated in FIG. 18, settings for Session Nos. 2 to 6 are similarly performed. A VM rotation management unit 103 repeatedly performing movement control according to Session Nos. 1 to 6 based on the rotation table T3 illustrated in FIG. 18, the hosts A to C are each switched to the guest VM operation state or the performance measurement target every three days.

Then, the following processes (f1) to (f6) are performed in the second example.

(f1) In the operation management server 10, a deterioration lower limit value used for deterioration judgment on a performance measurement result by the judgment unit 104 is recorded in the threshold table T2 (see step S21 of FIG. 7). A deterioration lower limit value is a value indicating a lower limit value of a difference (deterioration percent) of an in-operation performance value to an initial performance value acquired immediately after building. Now, FIG. 17 illustrates one example of the threshold table T2 set for the virtualization system 1 of the second example illustrated in FIG. 15. In the threshold table T2 illustrated in FIG. 17, a different deterioration lower limit value is set for each of host servers. More specifically, the deterioration lower limit values of 10%, 12%, and 8% are respectively set for the hosts A, B, and C.

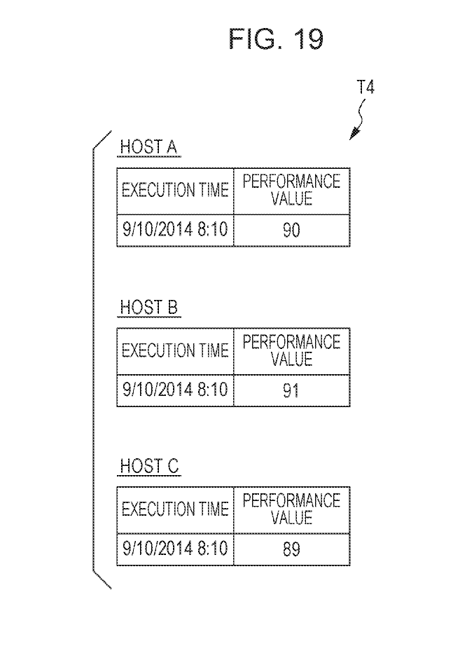

(f2) Immediately after building of the virtualization system 1, a guest VM for performance measurement 110 being copied (cloning) to each of the host servers 20A to 20C and activated, performance measurement is conducted without setting any guest VM other than the guest VM for performance measurement 110. This allows an initial performance value to be acquired for each of the host servers 20A to 20C in a state that conditions of every measurement are identical, and to be recorded in the benchmark performance value table T4 (see step S22 in FIG. 7). After performance measurement, the guest VM for performance measurement 110 copied to each of the host servers 20A to 20C is discarded. Here, FIG. 19 illustrates one example of the benchmark performance value table T4 in which an initial performance value measured for the virtualization system 1 of the second example illustrated in FIG. 15 is recorded. In the benchmark performance value table T4 illustrated in FIG. 19, in addition to the initial performance values of 90, 91 of the “host A” and the “host B” similar to FIG. 13, it is also recorded that the initial performance value of 89 was measured at execution time Sep. 10, 2014 8:10 of performance measurement for the “host C”.

(f3) After the processing (f2) described above is performed, the virtualization system 1 is in an operation state. In the operation state, in the virtualization system 1 illustrated in FIG. 15, an operating guest VM 120 is set and activated/operated on two host servers. In the case, the remaining one host server is for saving during performance measurement of one host server, and no operating guest VM 120 is set therefor. Then, according to the rotation table T3, the VM groups #1, #2 are moved between the host servers at a rotation interval set (see step S23 of FIG. 7). Then, the VM rotation management unit 103 starts with processing of Session No. 1 of the rotation table T3 illustrated in FIG. 18, sequentially performing processing of Session Nos. 2 to 6 at the rotation interval (3 days), and shifting to the processing of Session No. 1 at the rotation interval (3 days) after processing of Session No. 6. When shifting from the processing of Session No. 1 to the processing of Session No. 2, the VM rotation management unit 103 conducts performance measurement at the host B that does not have the guest VM 120 after moving the VM group #2 on the host B to host C. In addition, when shifting from the processing of Session No. 2 to processing of Session No. 3, the VM rotation management unit 103 conducts performance measurement at the host A that does not have the guest VM 120 after shifting the VM group #1 on the host A to the host B. Subsequently, similar processing is repeatedly performed for Session Nos. 4 to 6.

(f4) The performance measurement management unit 102 conducts performance measurement to acquire an in-operation performance value by copying the guest VM for performance measurement 110 to one of the host servers 20A to 20C targeted for performance measurement, and by activating the copied guest VM for performance measurement 110. The acquired in-operation performance value is recorded in the benchmark performance value table T4. After the performance measurement, the guest VM for performance measurement 110 copied to the host server targeted for performance measurement is discarded. Furthermore, the judgment unit 104 calculates the above-mentioned difference, with the above-mentioned expression [1], based on the initial performance value and the in-operation performance value, and records the difference in the benchmark performance value table T4 (see step S23 of FIG. 7). Now, FIG. 20 illustrates one example of the benchmark performance value table T4 in which the in-operation performance value measured for the virtualization system 1 of the second example illustrated in FIG. 15. In FIG. 20, for the “host B”, the in-operation performance value of 81 was measured at time Sep. 13, 2014 8:10, three days after the initial performance value was measured, the value of 11.0%, which corresponds to the difference between the in-operation performance value of 81 and the initial performance value of 91, is calculated with the above-mentioned expression [1], and the in-operation performance value of 81 and the difference of 11.0% are additionally recorded. In addition, in FIG. 20, for the “host A”, the in-operation performance value of 88 was measured at time Sep. 16, 2014 8:10, three days after the performance measurement of the host B was conducted, the value 2.2%, which corresponds to the difference between the in-operation performance value of 88 and the initial performance value of 90, is calculated with the above-mentioned expression [1], and the in-operation performance value of 88 and the difference of 2.2% are additionally recorded. Furthermore, in FIG. 20, for the “host C”, the in-operation performance value of 81 was measured at time Sep. 19, 2014 8:10, three days after the performance measurement of the host A was conducted, the value of 9.0%, which corresponds to the difference between the in-operation performance value of 81 and the initial performance value of 89, is calculated with the above-mentioned expression [1], and the in-operation performance value of 81 and the difference of 9.0% are additionally recorded.

(f5) The judgment unit 104 judges whether or not the difference recorded in the benchmark performance value table T4 exceeds the deterioration lower limit value in the threshold table T2 (see step S24 of FIG. 7). Since the difference of 2.2% between the in-operation performance value of 88 measured at time Sep. 16, 2014 8:10 for the host A and the initial performance value of 90 does not exceed the deterioration lower limit value of 10% for the host A, processing of a next session number is performed. Similarly, since the difference of 11.0% between the in-operation performance value of 81 measured at time Sep. 13, 2014 8:10 for the host B and the initial performance value of 91 does not exceed the deterioration lower limit value of 12% for the host B, processing of a next session number is performed. On the other hand, since the difference of 9.0% between the in-operation performance value of 81 measured at time Sep. 19, 2014 8:10 for the host C and the initial performance value of 89 exceeds the deterioration lower limit value of 8% for the host C, the rebuilding processing unit 105, the performance measurement management unit 102, and the judgment unit 104 perform the following process (f6) on the host C.

(f6) The rebuilding processing unit 105 initializes a host C to restore the host C to an initial state (initial configuration) of when the virtualization system 1 is built, by using information for rebuilding of the host C in the virtualization system host information table T1 and rebuilding the host C (see step S25 of FIG. 7). After the host C is rebuilt, the performance measurement management unit 102 conducts performance measurement to acquire a post-rebuilding performance value by copying the guest VM for performance measurement 110 to the host C after rebuilding and activating the copied guest VM for performance measurement 110. The acquired post-rebuilding performance value is recorded in the benchmark performance value table T4. After the performance measurement, the guest VM for performance measurement 110 copied to the host B after rebuilding is discarded. Furthermore, the judgment unit 104 calculates a difference, based on the initial performance value and the post-rebuilding performance value, by using an expression similar to the above-mentioned expression [1], and records the difference in the benchmark performance value table T4 (see step S26 of FIG. 7). Then, the judgment unit 104 judges whether or not the difference calculated after rebuilding exceeds the deterioration lower limit value in the threshold table T2 (see step S27 of FIG. 7). When the difference does not exceed the deterioration lower limit value, the operation management server 10 returns to processing of step S23, and performs processing of a next rotation interval. On the other hand, when the difference after rebuilding exceeds the deterioration lower limit value, the judgment unit 104 determines that some failure (abnormality) has occurred in the host C (see step S28 of FIG. 7) and notifies a manager or the like accordingly.

### [6] Effect of this Embodiment

As described above, with the virtualization system 1 including the operation management server 10 of this embodiment, performance measurement of a host server targeted for performance measurement is conducted with an operating guest VM 120 being moved from the host server targeted for performance measurement to another host server. This allows any performance deterioration (performance problem) due to the host system (management OS, hypervisor, management OS app, or the like of the host servers 20A to 20C) to be easily detected.

When performance measurement is conducted, an image of an identical guest VM for performance measurement 110 in the operation management server 10 is copied (cloning) to a host server targeted for performance measurement that has no operating guest VM 120 and the host server is operated. This allows measurement of an initial performance value, an in-operation performance value, or a post-rebuilding performance value of the host server targeted for performance measurement in a state where conditions of every measurement are identical.

Then, in this embodiment, it is judged based on an initial performance value and an in-operation performance value or a post-rebuilding performance value which is a result of performance measurement of the host server targeted for performance measurement whether or not the performance of the host server targeted for performance measurement is deteriorated. For example, when a difference between an initial performance value and an in-operation performance value exceeds a deterioration lower limit value, it is determined that performance deterioration occurs in the host server targeted for performance measurement, and the host server may be rebuilt so that the performance deterioration may be automatically repaired. Then, rebuilding may be automatically performed through the use of a disk image saved for the host server when operation starts or a building procedure script.

In addition, when a difference between the initial performance value and the post-rebuilding performance value exceeds the deterioration lower limit value, it may be judged that some failure (abnormality) has occurred in the host server, because the host server is in a performance deteriorated state even immediately after the rebuilding. Then, the failure (abnormality) may be addressed appropriately by notifying a manager or the like accordingly.

As described earlier with reference to FIG. 21, the existing operation management software is capable of analyzing the load statuses of multiple guest VMs on a host server, but is incapable of knowing the status of the host system on which the guest VMs are set. As a consequence, a manager manually detects or copes with performance deterioration on the host system, and significant time (a few days or more) or effort is consumed. However, with this embodiment, performance deterioration on the host system may be detected easily, as described above.

Furthermore, in this embodiment, performance verification (performance measurement and deterioration judgment) of each host server in operation and movement (rotation) of an operating guest VM 120 among host servers are managed by the rotation table T3 (see FIGS. 12 and 18), and automated. This enables maintenance and management of performance of the virtualization system 1 without stopping or affecting operation of a guest VM 120.

### [7] Other

While preferred embodiments of the present disclosure are described above, the present disclosure is not limited to such specific embodiments, and various variations or modifications may be made to the embodiments, which may be then implemented, without departing from the intent of the embodiments.

For example, in the embodiment described above, the case in which the virtualization system 1 has two or three host servers (information processing devices) is described. However, the present disclosure is not limited to this, and similar to the embodiment described above, the present disclosure may also be applied to a case in which the virtualization system 1 includes four or more host servers (information processing devices) and the operation and effect similar to the embodiment described above may be achieved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A system comprising:
a first information processing device;
a second information processing device; and
a management device configured to manage the first information processing device and the second information processing device, wherein
the management device is configured to:
perform movement control to move an operating virtual machine set on the first information processing device to the second information processing device, and
conduct performance measurement of the first information processing device in a state where the operating virtual machine set on the first information processing device is moved from the first information processing device to the second information processing device.

2. The system of claim 1, wherein
the management device includes a performance-measurement virtual machine configured to conduct the performance measurement of the first information processing device or the second information processing device; and
the management device conducts the performance measurement by:
copying an image of the performance-measurement virtual machine to the first information processing device or the second information processing device, and
causing the first information processing device or the second information processing device to execute the image of the performance-measurement virtual machine.

3. The system of claim 2, wherein
upon completing the performance measurement by using the image of the performance-measurement virtual machine, the management device discards the image of the performance-measurement virtual machine from the first information processing device or the second information processing device.

4. The system of claim 1, wherein
the management device conducts initial performance measurement of the first information processing device and the second information processing device at a time of building of the system; and
the management device determines whether the performance of the first information processing device is deteriorated, based on a result of the initial performance measurement and a result of the performance measurement of the first information processing device.

5. The system of claim 4, wherein
upon determining that the performance of the first information processing device is deteriorated, the management device rebuilds the first information processing device.

6. The system according to claim 5, wherein
at a time of building of the system, the management device saves a backup file of disk images for the first information processing device and the second information processing device, or saves a script of building procedures of the first information processing device and the second information processing device; and
the management device rebuilds the first information processing device by using the saved backup file or the saved script.

7. The system of claim 5, wherein
the management device:
conducts performance measurement of the first information processing device after rebuilding of the first information processing device is completed;
determines whether the performance of the first information processing device is deteriorated based on a result of the initial performance measurement and a result of the performance measurement after the rebuilding of the first information processing device is completed; and
upon determining that the performance of the first information processing device is deteriorated, determines that a failure has occurred in the first information processing device.

8. An apparatus comprising:
a processor configured to:
manage a first information processing device and a second information processing device included in an information processing system,
perform movement control to move an operating virtual machine set on the first information processing device to the second information processing device, and
conduct performance measurement of the first information processing device in a state where the operating virtual machine set on the first information processing device is moved from the first information processing device to the second information processing device; and
a memory coupled to the processor, the memory being configured to information for managing the first and second processing devices.

9. The apparatus of claim 8, wherein
the memory is configured to store a performance-measurement virtual machine configured to conduct performance measurement of the first information processing device or the second information processing device;
the processor conducts the performance measurement by copying an image of the performance-measurement virtual machine to the first information processing device or the second information processing device and causing the first information processing device or the second information processing device to execute the image of the performance-measurement virtual machine.

10. The apparatus of claim 9, wherein
upon completing the performance measurement by using the image of the performance-measurement virtual machine, the apparatus discards the image of the performance-measurement virtual machine from the first information processing device or the second information processing device.

11. The apparatus of claim 8, wherein
the processor conducts initial performance measurement of the first information processing device and the second information processing device at a time of building of the system; and
the processor determines whether the performance of the first information processing device is deteriorated, based on a result of the initial performance measurement and a result of the performance measurement of the first information processing device.

12. The apparatus of claim 11, wherein
upon determining that the performance of the first information processing device is deteriorated, the processor rebuilds the first information processing device.

13. The apparatus of claim 12, wherein
at a time of building of the system, the processor saves a backup file of disk images for the first information processing device and the second information processing device, or saves a script of building procedures of the first information processing device and the second information processing device; and
the processor rebuilds the first information processing device by using the saved backup file or the saved script.

14. The apparatus of claim 12, wherein
the processor:
conducts performance measurement of the first information processing device after rebuilding of the first information processing device is completed;
determines whether the performance of the first information processing device is deteriorated based on a result of the initial performance measurement and a result of the performance measurement after the rebuilding of the first information processing device is completed; and
upon determining that the performance of the first information processing device is deteriorated, determines that a failure has occurred in the first information processing device.

15. A method for managing a first information processing device and a second information processing device included in an information processing system, the method comprising causing a computer to:
perform movement control to move an operating virtual machine set on the first information processing device to the second information processing device; and
conduct performance measurement of the first information processing device in a state where the operating virtual machine set on the first information processing device is moved from the first information processing device to the second information processing device.

16. The method of claim 15, wherein
the computer includes a performance-measurement virtual machine configured to conduct the performance measurement of the first information processing device or the second information processing device; and
the computer conducts the performance measurement by copying an image of the performance-measurement virtual machine to the first information processing device or the second information processing device and causing the first information processing device or the second information processing device to execute the image of the performance-measurement virtual machine.

17. The method of claim 15, wherein
the computer conducts initial performance measurement of the first information processing device and the second information processing device at a time of building of the information processing system, and
the computer determines whether the performance of the first information processing device is deteriorated, based on a result of the initial performance measurement and a result of the performance measurement of the first information processing device.

18. The method of claim 17, wherein
upon determining that the performance of the first information processing device is deteriorated, the processor rebuilds the first information processing device.

19. The method of claim 18, wherein
at a time of building of the information processing system, the computer saves a backup file of disk images in the first information processing device and the second information processing device, or a script of building procedures of the first information processing device and the second information processing device, and
the computer rebuilds the first information processing device by using the saved backup file or the saved script.

20. The method of claim 18, wherein
the computer conducts performance measurement of the first information processing device after the rebuilding is completed, and
the computer determines whether the performance of the first information processing device is deteriorated based on a result of the initial performance measurement and a result of the performance measurement after the rebuilding is completed, and determines that a failure has occurred in the first information processing device when the computer determines that the performance of the first information processing device is deteriorated.
